(19) United States
(12) Patent Application Publication
(10) Pub. No.: US 2024/0138031 A1
(43) Pub. Date: Apr. 25, 2024

(54) COOKTOP APPLIANCE AND HEATING ASSEMBLIES FOR EVEN HEAT DISTRIBUTION ACROSS MULTIPLE ELECTRIC HEATING ELEMENTS

(71) Applicant: Haier US Appliance Solutions, Inc., Wilmington, DE (US)

(72) Inventor: Kenneth Willard Johnson, Ringgold, GA (US)

(21) Appl. No.: 17/969,929

(22) Filed: Oct. 19, 2022

(51) Int. Cl. H05B 3/68

(52) U.S. Cl. CPC H05B 3/68; H05B 2203/005; H05B 2203/037

(57) ABSTRACT

A cooktop appliance may include a top panel and a heating assembly mounted to the top panel. The heating assembly may include a first electric heating element and a second electric heating element. The first electric heating element may define a first heating zone in a horizontal plane to receive a cooking utensil thereon. The first electric heating element may have a set wattage density in the first heating zone. The second electric heating element may define a second heating zone in the horizontal plane to receive the cooking utensil thereon. The second heating zone may be horizontally spaced apart from the first heating zone. Moreover, the second electric heating element may have a set wattage density in the second heating zone. The set wattage density of the first electric heating element may be matched to the set wattage density of the second electric heating element.

### FIELD OF THE INVENTION

The present subject matter relates generally to cooktop appliances having one or more heating elements, including features for matching heat output.

### BACKGROUND OF THE INVENTION

Certain cooktop appliances include electric heating elements for heating pots, pans and other containers with food items therein. The electric heating elements can be operated at various settings. For example, the electric heating elements can be operated at a low heat setting to simmer food items, or the electric heating elements can be operated at a high heat setting to boil water or fry food items.

In some cooktop appliances, the heating elements are mounted below a cooking surface, such as might be defined by a cooktop plate. For instance, radiant heating elements may be disposed directly beneath the cooktop plate. Certain large area radiant burners include multiple concentrically positioned zones and relays for selectively activating each zone of the burner.

Issues can arise when operating existing appliances or heating elements. Multi-zone burners, in particular, can have difficulties maintaining a consistent or even temperature across the bottom of a cooking utensil. In other words, certain cooking zones can heat up corresponding portions of a cooking utensil faster than other cooking zones can heat up their own corresponding portions of the cooking utensil. This can be especially problematic when cooking sauces or sauteing (e.g., in a relatively thin-walled cooking utensil). It can also be problematic when cooking large food items (e.g., steaks), for instance on high heat settings, since certain parts of the food can cook or sear on only part of one side before the rest of that side is able to be similarly cooked or seared. This can lead to improperly cooked food or user frustration as a user struggles to constantly move a cooking utensil or food item to maintain an even heat distribution.

As a result, it would be useful to provide an appliance with one or more features to address the above-described issues. For instance, it may be advantageous to provide an appliance or heating assembly capable of ensuring an even heat distribution or output across multiple electric (e.g., radiant) heating elements.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooktop appliance is provided. The cooktop appliance may include a top panel and a heating assembly mounted to the top panel. The heating assembly may include a first electric heating element and a second electric heating element. The first electric heating element may define a first heating zone in a horizontal plane to receive a cooking utensil thereon. The first electric heating element may have a set wattage density in the first heating zone. The second electric heating element may define a second heating zone in the horizontal plane to receive the cooking utensil thereon. The second heating zone may be horizontally spaced apart from the first heating zone. Moreover, the second electric heating element may have a set wattage density in the second heating zone. The set wattage density of the first electric heating element may be matched to the set wattage density of the second electric heating element.

In another exemplary aspect of the present disclosure, a cooktop appliance is provided. The cooktop appliance may include a top panel defining an upper cooking surface and a plurality of heating assemblies mounted to the top panel. The plurality of heating assemblies may be horizontally spaced apart below the upper cooking surface. At least one heating assembly of the plurality of heating assemblies may include a first electric heating element and a second electric heating element. The first electric heating element may define a first heating zone in a horizontal plane to receive a cooking utensil thereon. The first electric heating element may have a set wattage density in the first heating zone. The second electric heating element may define a second heating zone in the horizontal plane to receive the cooking utensil thereon. The second heating zone may be horizontally spaced apart from the first heating zone. Moreover, the second electric heating element may have a set wattage density in the second heating zone. The set wattage density of the first electric heating element may be matched to the set wattage density of the second electric heating element.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top, plan view of a cooktop appliance according to exemplary embodiments of the present disclosure.

FIG. 2 provides a top plan view of a heating assembly of the exemplary cooktop appliance of FIG. 1, wherein a top panel has been removed for clarity.

FIG. 3 provides a top plan view of a heating assembly of the exemplary cooktop appliance of FIG. 1, wherein a top panel has been removed and multiple heating zones have been overlaid with hatching marks for clarity.

FIG. 4 provides a cross-sectional, schematic, elevation view of certain components of the exemplary heating assembly of FIG. 2.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

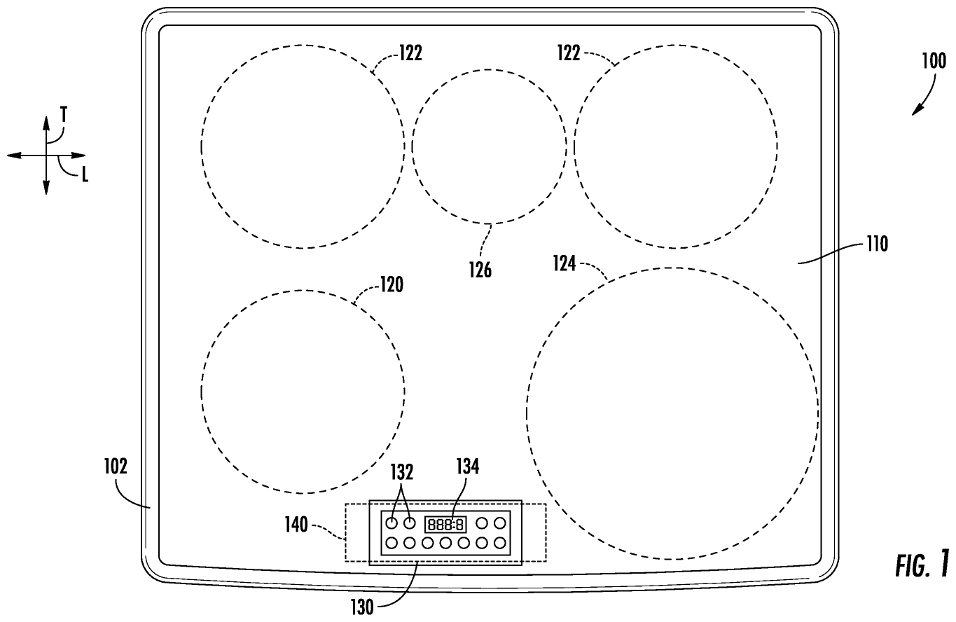

Turning now to the figures, FIG. 1 provides a top, plan view of a cooktop appliance 100 according to exemplary embodiments of the present disclosure. Cooktop appliance 100 can be installed in various locations such as in cabinetry in a kitchen, with one or more ovens to form a range appliance, or as a standalone appliance. Thus, as used herein, the term “cooktop appliance” includes grill appliances, stove appliances, range appliances, and other appliances that incorporate cooktops.

According to exemplary embodiments, appliance 100 includes a cabinet 102 that is generally configured for containing or supporting various components of appliance 100 and which may also define one or more internal chambers or compartments of appliance 100. In this regard, as used herein, the terms “cabinet,” “housing,” and the like are generally intended to refer to an outer frame or support structure for appliance 100, (e.g., including any suitable number, type, and configuration of support structures formed from any suitable materials, such as a system of elongated support members, a plurality of interconnected panels, or some combination thereof.) It should be appreciated that cabinet 102 does not necessarily require an enclosure and may simply include open structure supporting various elements of appliance 100. By contrast, cabinet 102 may enclose some or all portions of an interior of cabinet 102. It should be appreciated that cabinet 102 may have any suitable size, shape, and configuration while remaining within the scope of the present subject matter.

Cabinet 102 generally defines a mutually orthogonal vertical, lateral, and transverse direction. Cabinet 102 extends between a top and a bottom along the vertical direction V, between a first side (e.g., the left side when viewed from the front as in FIG. 1) and a second side (e.g., the right side when viewed from the front as in FIG. 1) along the lateral direction L, and between a front and a rear along the transverse direction T. In general, terms such as “left,” “right,” “front,” “rear,” “top,” or “bottom” are used with reference to the perspective of a user accessing appliance 100.

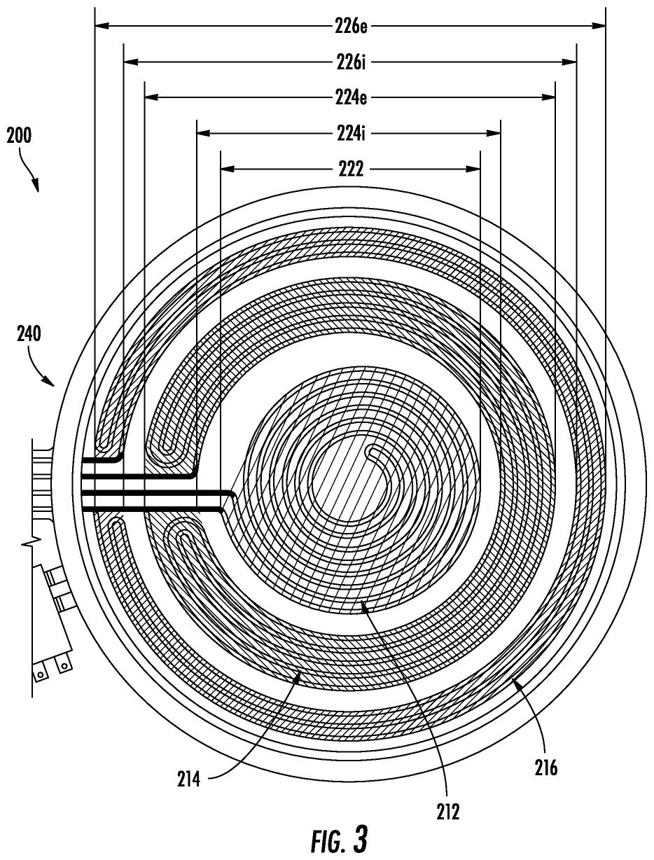

Cooktop appliance 100 includes a cooktop plate 110 (e.g., mounted to cabinet 102) for supporting cooking utensils, such as pots or pans, on a cooking or top surface 114 of cooktop plate 110. Optionally, cooktop plate 110 may be fixed or secured to cabinet 102 at its perimeter edge (e.g., such that the sides or edges of cooktop plate 110 rest on a more rigid structure—or are otherwise prevented from deflected more than—a central portion of cooktop plate 110). When assembled, a top surface 114 is directed vertically upward to contact cooking utensils, while a bottom interior surface 112 is directed vertically downward opposite the top surface 114 (e.g., toward a support panel 116 mounted below cooktop plate 110). Cooktop plate 110 may be any suitable rigid plate, such as one formed of ceramic or glass (e.g., glass ceramic). As will be described in greater detail below, one or more electric heating assemblies 120, 122, 124 are mounted below cooktop plate 110 such that heating assemblies 120, 122, 124, and 126 are positioned below cooktop plate 110 (e.g., below the bottom interior surface 112 along the vertical direction V—FIG. 3). Cooktop plate 110 may be continuous over heating assemblies 120, 122, 124, and 126. Thus, no holes may extend vertically through cooktop plate 110 above heating assemblies 120, 122, 124, and 126. However, it will be understood that a hole may extend through cooktop plate 110 at one of heating assemblies 120, 122, 124, and 126, in certain exemplary embodiments.

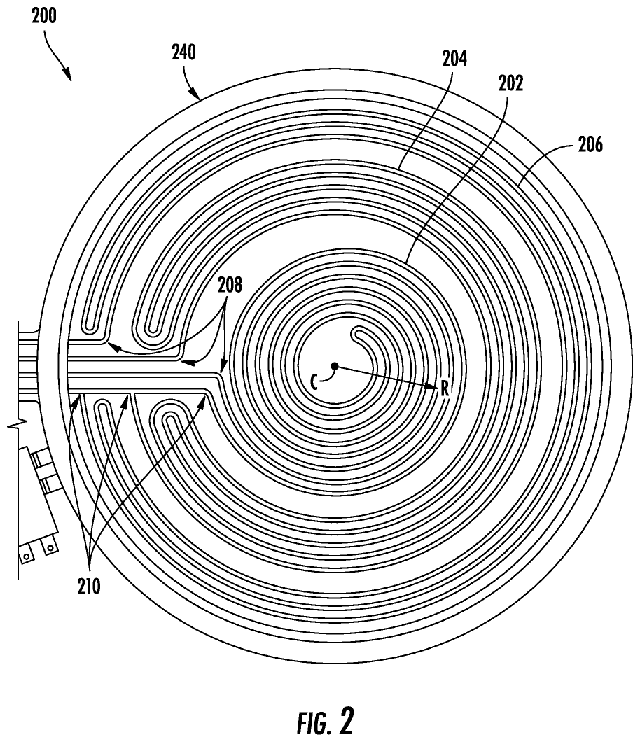

While shown with four heating assemblies 120, 122, 124, and 126 in the exemplary embodiment of FIG. 1, cooktop appliance 100 may include any number of heating assemblies 120, 122, 124, and 126 in alternative embodiments. Heating assemblies 120, 122, 124, and 126 can also have various diameters. For example, each heating assembly of heating assemblies 120, 122, 124, and 126 can have a different diameter, the same diameter, or any suitable combination thereof. In addition, the heating elements 120, 122, 124, and 126 may include differing numbers or shapes of heating elements (e.g., 202, 204, 206—FIG. 2), as shown. Nonetheless, cooktop appliance 100 is provided by way of example only and is not limited to the exemplary embodiment shown in FIG. 1. For example, a cooktop appliance having one or more radiant heating assemblies in combination with one or more electric resistance or gas burner heating elements can be provided. In addition, various combinations of number of heating assemblies, position of heating assemblies or size of heating assemblies can be provided. It will also be understood that the present subject matter is suitable for use with other electric heating elements, such as induction heating elements or resistive heating elements.

Generally, a user interface 130 provides visual information to a user and allows a user to select various options for the operation of cooktop appliance 100. For example, displayed options can include a desired heating assemblies 120, 122, 124, and 126, a desired cooking temperature, or other options. User interface 130 can be any type of input device and can have any configuration. In FIG. 1, user interface 130 is located within a portion of cooktop plate 110. Alternatively, user interface 130 can be positioned on a vertical surface near a front side of cooktop appliance 100 or at another location that is convenient for a user to access during operation of cooktop appliance 100.

In some embodiments, such as that shown in FIG. 1, user interface 130 includes a capacitive touch screen input device component 132. Capacitive touch screen input device component 132 can allow for the selective activation, adjustment or control of any or all heating assemblies 120, 122, 124, and 126 as well as any timer features or other user adjustable inputs. One or more of a variety of electrical, mechanical, or electro-mechanical input devices including rotary dials, push buttons, toggle/rocker switches, or touch pads can also be used singularly or in combination with capacitive touch screen input device component 132. User interface 130 also includes a display component 134, such as a digital or analog display device designed to provide operational feedback to a user.

Generally, cooktop appliance 100 includes a controller 140. Operation of cooktop appliance 100 is regulated by controller 140. Controller 140 is operatively coupled or in communication with various components of cooktop appliance 100, including user interface 130. In response to user manipulation of the user interface 130, controller 140 operates the various components of cooktop appliance 100 to execute selected cycles and features.

Controller 140 may include memory (e.g., non-transitory media) and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 140 may be constructed without using a microprocessor (e.g., using a combination of discrete analog or digital logic circuitry, such as switches, amplifiers, integrators, comparators, flip-flops, AND gates, and the like) to perform control functionality instead of relying upon software. Heating assemblies (e.g., 120, 124, 122, or 126), user interface 130 and other components of cooktop appliance 100 may be in communication with controller 140 via one or more signal lines or shared communication busses.

Turning now generally to FIGS. 2 through 4, various portions of the exemplary appliance 100 are illustrated and will be described in greater detail, especially with respect to a multi-element assembly 200 (e.g., heating assembly 124).

As noted above, the heating assemblies 120, 122, 124, and 126 are generally disposed below cooktop plate 110. In some embodiments, a multi-element assembly 200 is mounted between support panel 116 and cooktop plate 110 relative to the vertical direction V. As shown, multi-element assembly 200 may include a frame 240 on which one or more electric heating elements (e.g., heating elements 202, 204, 206) are supported. As would be understood, frame 240 may include a number of discrete parts and materials to support and enclose heating elements 202, 204, 206. In particular, frame 240 may include a suitable base wall 242 and insulated wall 244 extending from base wall 242 (e.g., in the vertical direction V towards cooktop plate 110). Optionally, a metal pan 248 may further enclose at least a portion (e.g., bottom portion) of base wall 242 or insulated wall 244.

When assembled, frame 240 is positioned below cooktop plate 110. In particular, insulated wall 244 may be positioned beneath bottom interior surface 112. An upper edge of insulated wall 244 may even rest against or contact bottom interior surface 112 (e.g., directly or indirectly, such as through an intermediate rim or gasket). As shown, frame 240 may circumferentially surrounds one or more electric heating elements 202, 204, 206. For example, insulated wall 244 may be formed as a circular ring or loop (e.g., as a toroid having a rectangular cross section) positioned about center point (e.g., coaxial to heating elements 202, 204, 206). Thus, insulated wall 244 may bound (e.g., extend about) the perimeter of the footprint of the corresponding heating elements 202, 204, 206. Generally, insulated wall 244 includes or is formed from any suitable insulation material, such as ceramic or metallic insulation materials.

Optionally, a support panel 116 disposed below (e.g., beneath) the cooktop plate 110. For instance, support panel 116 may be mounted to cabinet 102 (or adjacent structure) via one or more suitable mechanical fasteners, adhesives, etc.—as would be understood. Thus, support panel 116 is generally fixed relative to cooktop plate 110 (though relative deflection of either may occur, such as during use or shipping). Moreover, support panel 116 may be spaced apart from cooktop plate 110 along the vertical direction V. In turn, an enclosure gap or cavity 104 may be defined between support panel 116 and cooktop plate 110 (e.g., by the vertical distance between an upper surface of support panel 116 and bottom interior surface 112). Generally, support panel 116 may be formed from any suitable rigid, high-heat material, such as a metal material formed from a stainless steel or aluminum sheet (e.g., including alloys thereof).

Generally, multi-element assembly 200 includes a plurality of discrete electric heating elements (e.g., 202, 204, 206) that are horizontally spaced apart from each other (e.g., along a radial direction R perpendicular to the vertical direction V). As would be understood, each of the electric heating elements may be in electrical communication with a power source or controller 140. Each heating element 202, 204, 206 generally extends along a length or path between a first element end 208 and a second element end 210, which are electrically connected to a power circuit via one or more wires, connectors, busses, etc. at each end. Moreover, one or more control switches or relays (not pictured) may be provided (e.g., with the controller or power circuit) for each electric heating element to selectively activate and deactivate the corresponding electric heating element, as would also be understood.

When assembled, each electric heating element elements 202, 204, 206 defines a corresponding heating zone 212, 214, 216 on a corresponding horizontal plane H (e.g., defined by the top surface 112) on which a cooking utensil 250 may be received. For instance, a first (e.g., inner) heating element 202 may define a first heating zone 212 (e.g., in the portion of the horizontal plane H that is directly above the first heating element 202). Additionally or alternatively, a second (e.g., outer or intermediate) heating element 204 may define a second heating zone 214 (e.g., in the portion of the horizontal plane H that is directly above the second heating element 204). Further additionally or alternatively, a third (e.g., outer or outermost) heating element 206 may define a third heating zone 216 (e.g., in the portion of the horizontal plane H that is directly above the third heating element 206).

In some embodiments, one or more of the heating zones 212, 214, 216 are defined by solely by a corresponding heating element 202, 204, 206. Thus, a heating zone may only occupy the two dimensional area that is above directly above a corresponding heating element, including any radial gaps provided between adjacent passes or ring segments of the same heating element. The coverage of corresponding heating zones is illustrated, especially in FIG. 3.

Generally, any suitable shape may be defined by a heating zone. In the illustrated embodiments, the heating zones are formed about a centerpoint C of heating assembly 200. The first heating zone 212 is defined within a first zone (FZ) diameter 222 (e.g., delineated or defined by a radially outermost pass or segment of first heating element 202). The first heating element 202 is coiled about centerpoint C, and first heating zone 212 may span the footprint or area encircled by the radially outermost portion of first heating element 202 surrounding centerpoint C. Thus, although second first heating zone 212 may or may not be perfectly circular, the area of the second heating zone 214 may generally be enclosed within the FZ diameter 222.

In certain embodiments, second heating zone 214 generally wraps around the first heating zone 212. Second heating zone 214 may be defined between a radially innermost or interior second zone (SZi) diameter 224i and an outermost or exterior second zone (SZe) diameter 224e. The second heating element 204 is coiled about centerpoint C and first heating zone 212. Second heating zone 214 may generally span the ring-shaped footprint or radial area between the SZi diameter 224i and the SZe diameter 224e. Nonetheless, as shown, a radial pass may be defined between the SZi diameter 224i and the SZe diameter 224e (e.g., to permit the passage or arrangement of wires connecting first and second element ends 208, 210) such that the second heating zone 214 is not perfectly circular. Thus, although the second heating zone 214 may or may not be perfectly circular, the area of the second heating zone 214 may generally be enclosed within the ring or C-shaped area between the SZi diameter 224i and the SZe diameter 224e. Optionally, the second heating zone 214 may be larger than the first heating zone 212. In other words, the area spanned by the second heating zone 214 in the horizontal plane H may be larger than the area spanned by the first heating zone 212 in the horizontal plane H.

In optional embodiments, third heating zone 216 generally wraps around the second heating zone 214. Third heating zone 216 may be defined between a radially innermost or interior third zone (TZi) diameter 226i and an outermost or exterior third zone (TZe) diameter 226e. The third heating element 206 is coiled about centerpoint C and second heating zone 214. Third heating zone 216 may generally span the ring-shaped footprint or radial area between the TZi diameter 226i and the TZe diameter 226e. Nonetheless, as shown, a radial pass may be defined between the TZi diameter 226i and the TZe diameter 226e (e.g., to permit the passage or arrangement of wires connecting first and second element ends 208, 210) such that the third heating zone 216 is not perfectly circular. Thus, although the third heating zone 216 may or may not be perfectly circular, the area of the third heating zone 216 may generally be enclosed within the ring C-shaped area between the TZi diameter 226i and the TZe diameter 226e. Optionally, the third heating zone 216 may be larger than the first or second heating zones 212, 214. In other words, the area spanned by the third heating zone 216 in the horizontal plane H may be larger than the area spanned by the first or second heating zones 212, 214 in the horizontal plane H.

As shown, in certain embodiments, two or more heating zones are non-overlapping (e.g., in the horizontal plane H). For instance, no portion of the first heating zone 212 permeates, covers, or is covered by the second heating zone 214 or the third heating zone 216 in the horizontal plane. Similarly, no portion of the second heating zone 214 may permeate, cover, or be covered by the third heating zone 216 in the horizontal plane H.

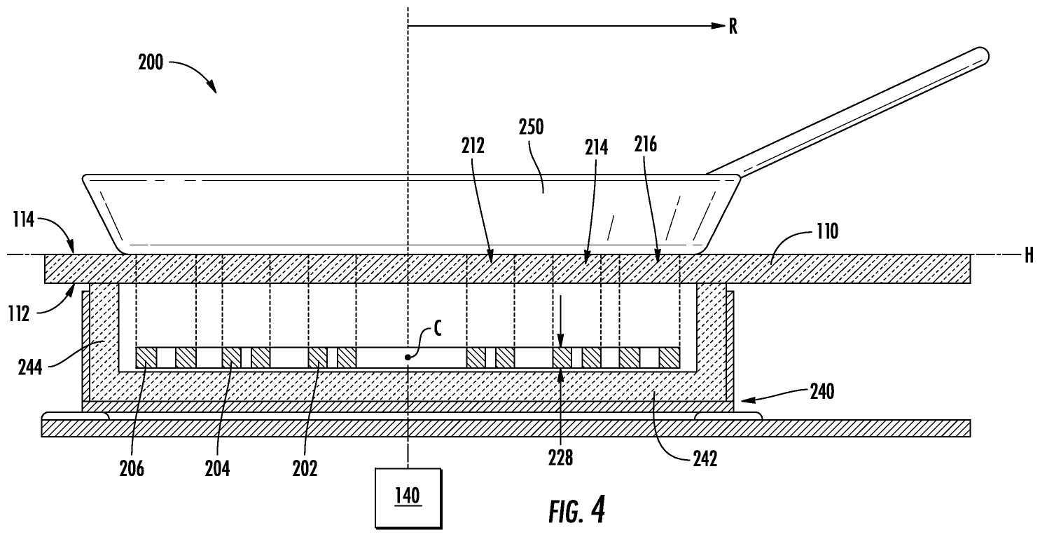

Turning especially to FIG. 4, when assembled, each heating element 202, 204, 206 generally defines a thread diameter 228. As illustrated, the thread diameter 228 may be generally defined by the cross-section of the corresponding heating element (e.g., parallel to the vertical direction V). Thus, the thread diameter 228 may be considered the thickness of the corresponding heating element. Optionally, two or more of the heating elements may have a matched or common thread diameter 228. Thus, two or more heating elements may have substantially the same thread diameter 228. In the illustrated embodiments, the first electric heating element 202 and the second electric heating element 204 define a common thread diameter 228. In other words, the cross-sectional area perpendicular to the horizontal plane H of the heat-emitting ribbon forming the first electric heating element 202 is the same (e.g., within manufacturing tolerances) as the cross-sectional area of the heat-emitting ribbon forming the second electric heating element 204. In additional or alternative embodiments, the second electric heating element 204 and the third electric heating element 206 define a common thread diameter 228.

Optionally, two or more heating elements may be disposed at the same height or vertical position (e.g., within a frame 240). For instance, the second electric heating element 204 may be parallel to the first electric heating element 202 relative to the vertical direction V. Additionally or alternatively, the third electric heating element 206 may be parallel to the second electric heating element 204 relative to the vertical direction V. Although FIG. 4 illustrates the first, second, and third heating elements 202, 204, 206 as parallel elements, alternative embodiments may vary the vertical height of one or more of the heating elements 202, 204, 206 (e.g., along the path of the ribbon between the first element end 208 and second element end 210). For instance, one or more of the heating elements 202, 204, 206 may provide a vertically crimped shape or path such that the crimped heating element defines multiple discrete vertical peaks and vertical valleys between the corresponding first and second element ends 208, 210. Such a crimped shape may be formed, for instance, by pinching or bending certain segments of the corresponding element 202, 204, 206 and, thereby, increases the surface area of the heating element 202, 204, 206 within the footprint of the corresponding heating zone 212, 214, 215.

Returning generally to FIGS. 2 through 4, two or more of the heating elements 202, 204, 206 may have a matched wattage density. In other words, one electric heating element may have a set wattage density that is matched to a set wattage density of another electric heating element. Wattage density, as it is understood, represents the energy output (E) (e.g., in Watts) of a heating element relative to the surface area of the heating element. As would be understood the surface area (SA) may be a function of the overall length of the heating element (e.g., along the path from the corresponding first element end 208 to the second element end 210) and the cross-sectional area (e.g., as defined by the thread diameter 228).

Generally, energy output may be proportional to the size (e.g., length) of a heating element, as illustrated below:

E=I*V=I²*R=I²*(ρ*l/A);
wherein:
   E is energy rating of the heating element (e.g., in Watts),
   I is current supplied to the heating element (e.g., in Amperes),
   V is voltage supplied to the heating element (e.g., in volts),
   R is resistivity of the heating element (e.g., in ohms or Ω),
   ρ is resistivity of the heating element (e.g., in ohm-meters or Ωm),
   l is overall length of the heating element (e.g., in meters along the
   path from the corresponding first element end to the second element end), and
   A is cross sectional area of the heating element (e.g., in square meters, such as may be defined by the half of the thread diameter multiplied by π).

The first heating element 202 may have a first set energy output rate (E1) and be formed with a first surface area (SA1) in the first heating zone 212. The set wattage density (D1) of the first heating element 202 may thus be defined as (E1/SA1). In other words, D1=(E1/SA1). Similarly, the second heating element 204 may have a second set energy output rate (E2) and be formed with a second surface area (SA2) in the second heating zone 214. The set wattage density (D2) of the second heating element 204 may thus be defined as (E2/SA2). In other words, D2=(E2/SA2). In some embodiments, the set wattage density (D1) of the first electric heating element 202 is matched or substantially equal to the set wattage density (D2) of the second electric heating element 204. In some such embodiments, D1=D2. As would be understood, the wattage densities of additional heating elements may be similarly matched. For instance, the third heating element 206 may have a third set energy output rate (E3) and be formed with a third surface area (SA3) in the third heating zone 216 such that wattage density (D3) of the third heating element 206 is defined as (E3/SA3) and D3=D2=D1.

In certain embodiments, the overall length of the heating elements 202, 204, 206 is tuned to provide matched set wattage densities between two or more heating elements 202, 204, 206. Thus, while maintaining a predetermined energy output, heating zone area, or cross-sectional area, the geometry (e.g., length) of each heating element 202, 204, 206 may be selected as a function of a set wattage density. For instance, at least one heating element 202, 204, 206 may be crimped or bent while being extended across the same number of passes or area of the corresponding heating zone 212, 214, 216 to increase the overall length of the at least one heating element 202, 204, 206 and thereby increase the set wattage density of the at least one heating element 202, 204, 206.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance comprising:
a top panel; and
a heating assembly mounted to the top panel, the heating assembly comprising:
a first electric heating element defining a first heating zone in a horizontal plane to receive a cooking utensil thereon, the first electric heating element having a set wattage density in the first heating zone, and
a second electric heating element defining a second heating zone in the horizontal plane to receive the cooking utensil thereon, the second heating zone being horizontally spaced apart from the first heating zone, and the second electric heating element having a set wattage density in the second heating zone,
wherein the set wattage density of the first electric heating element is matched to the set wattage density of the second electric heating element.

2. The cooktop appliance of claim 1, wherein the second heating zone is nonoverlapping with the first heating zone.

3. The cooktop appliance of claim 2, wherein the first electric heating element and the second electric heating element define a common thread diameter.

4. The cooktop appliance of claim 1, wherein the heating assembly defines a centerpoint, wherein the first electric heating element is coiled about the centerpoint, and wherein the second electric heating element is coiled about the centerpoint and the first heating zone.

5. The cooktop appliance of claim 1, wherein the second electric heating element is parallel to the first electric heating element relative to a vertical direction.

6. The cooktop appliance of claim 1, wherein the heating assembly further comprises a frame comprising a bottom wall and an insulated wall extending vertically from the bottom wall, the bottom wall supporting the first and second electric heating elements, and the insulated wall surrounding the first and second electric heating elements.

7. The cooktop appliance of claim 1, wherein the second heating zone is larger than the first heating zone.

8. The cooktop appliance of claim 1, wherein the first electric heating element has a set energy output rate, and wherein the second electric heating element has a set energy output rate matched to the set energy output rate of the first electric heating element.

9. The cooktop appliance of claim 1, wherein the heating assembly further comprises
a third electric heating element defining a third heating zone in the horizontal plane to receive the cooking utensil thereon, the third heating zone being horizontally spaced apart from the first and second heating zones, and the third electric heating element having a set wattage density in the third heating zone, and
wherein the set wattage density of the third electric heating element is matched to the set wattage density of the first and second electric heating elements.

10. A cooktop appliance comprising:
a top panel defining an upper cooking surface; and
a plurality of heating assemblies mounted to the top panel, the plurality of heating assemblies being horizontally spaced apart below the upper cooking surface, at least one heating assembly of the plurality of heating assemblies comprising
a first electric heating element defining a first heating zone in a horizontal plane at the upper cooking surface to receive a cooking utensil thereon, the first electric heating element having a set wattage density in the first heating zone, and
a second electric heating element defining a second heating zone in the horizontal plane at the upper cooking surface to receive the cooking utensil thereon, the second heating zone being horizontally spaced apart from the first heating zone, and the second electric heating element having a set wattage density in the second heating zone,
wherein the set wattage density of the first electric heating element is matched to the set wattage density of the second electric heating element.

11. The cooktop appliance of claim 10, wherein the second heating zone is nonoverlapping with the first heating zone.

12. The cooktop appliance of claim 11, wherein the first electric heating element and the second electric heating element define a common thread diameter.

13. The cooktop appliance of claim 10, wherein the at least one heating assembly defines a centerpoint, wherein the first electric heating element is coiled about the centerpoint, and wherein the second electric heating element is coiled about the centerpoint and the first heating zone.

14. The cooktop appliance of claim 10, wherein the second electric heating element is parallel to the first electric heating element relative to a vertical direction.

15. The cooktop appliance of claim 10, wherein the at least one heating assembly further comprises a frame comprising a bottom wall and an insulated wall extending vertically from the bottom wall, the bottom wall supporting the first and second electric heating elements, and the insulated wall surrounding the first and second electric heating elements.

16. The cooktop appliance of claim 10, wherein the second heating zone is larger than the first heating zone.

17. The cooktop appliance of claim 10, wherein the first electric heating element has a set energy output rate, and wherein the second electric heating element has a set energy output rate matched to the set energy output rate of the first electric heating element.

18. The cooktop appliance of claim 10, wherein the at least one heating assembly further comprises
a third electric heating element defining a third heating zone in the horizontal plane to receive the cooking utensil thereon, the third heating zone being horizontally spaced apart from the first and second heating zones, and the third electric heating element having a set wattage density in the third heating zone, and
wherein the set wattage density of the third electric heating element is matched to the set wattage density of the first and second electric heating elements.
